(19) United States
(12) Patent Application Publication
(10) Pub. No.: US 2003/0014466 A1
(43) Pub. Date: Jan. 16, 2003

(54) System and method for management of compartments in a trusted operating system

(76) Inventors: Joubert Berger, Atlanta, GA (US); Scott A. Leerssen, Atlanta, GA (US); Tse Huong Choo, Stoke Bristol (GB); Richard B. Stock, North Somerset (GB); Christopher I. Dalton, Redland Bristol (GB); Andrew Patrick Norman, Stoke Bristol (GB)

Correspondence Address: HEWLETT-PACKARD COMPANY, Intellectual Property Administration, P.O. Box 272400, Fort Collins, CO, 80527-2400, US

(21) Appl. No.: 09/896,385

(22) Filed: Jun. 29, 2001

(51) Int. Cl. G06F 9/00

(52) U.S. Cl. 709/102

(57) ABSTRACT

A system and method are disclosed which enable management of compartments implemented by an OS for defining containment in a system. In one embodiment, a method of administering a processor-based system is disclosed, which comprises implementing at least one compartment for containing at least one process, and providing at least one command-line utility executable to manipulate the compartment(s). A system is also disclosed that comprises an operating system that implements compartment(s) to which process(es) can be associated. The system further includes at least one configuration file defines the compartment(s), and means for performing management of the compartment(s) without requiring that a user edit the configuration file(s). A computer-readable medium is also disclosed that comprises a library of software functions for managing compartment(s) implemented by an operating system. Such library includes at least one command-line utility executable to manipulate the compartment(s).

### BACKGROUND

An Operating System (OS) is arguably the most important program executing on a computer system, because the OS is utilized in executing all other programs (which are commonly referred to as “applications”). In general, the OS provides functionality that applications may then utilize. For instance, an application may invoke an OS routine (e.g., via a system call) to save a particular file, and the OS may interact with the basic input/output system (BIOS), dynamic link libraries, drivers, and/or other components of the computer system to properly save the particular file. Many different OSs have been developed in the prior art, including BP-UX®, Linux™, MS-DOS®, OS/2®, Windows®, Unix™, System 8, MPE/iX, Windows CE®, and Palm™, as examples.

FIG. 1 shows an exemplary system 100, which includes an OS 101. As shown, OS 101 may perform such tasks as recognizing input from keyboard 106 and mouse 104, sending output to display screen 107, and controlling peripheral devices, such as disk drive 103 and printer 105. Some OSs have integrated therein relatively complex functions that were once performed only by separate programs, such as faxing, word processing, disk compression, and Internet browsers. Generally, OSs provide a software platform on top of which other programs, such as application 102, can execute. Application programs are generally written to execute on top of a particular OS, and therefore, the particular OS implemented on a computer system may dictate, to a large extent, the types of applications that can be executed on such computer system.

Application 102 executing on computer system 100 may rely on operating system routines to perform such basic tasks as recognizing input from keyboard 106 and mouse 104, as well as sending output to display screen 107, as examples. OS 101 comprises sets of routines for performing various tasks (e.g., low-level operations). For example, operating systems commonly include routines for performing such tasks as creating a directory, opening a file, closing a file, and saving a file, as examples. Application 102 may invoke certain OS routines to perform desired tasks by making a system call. That is, applications generally invoke OS routines via system calls. Also, a user may interact with OS 101 through a set of commands. For example, the DOS operating system contains commands such as COPY and RENAME for copying files and changing the names of files, respectively. The commands are accepted and executed by a part of the OS called the command processor or command line interpreter. Additionally, a graphical user interface may be provided to enable a user to enter commands by pointing and clicking objects appearing on the display screen, for example.

OSs may have many responsibilities in addition to those described above. For example, OSs may also have responsibility for ensuring that different applications and users running at the same time do not interfere with each other. OSs may further have responsibility for security, e.g., ensuring that unauthorized users do not access the system (or at least forbidden portions of the system). For instance, “trusted” (secure) OSs that include security mechanisms therein have been developed in the prior art, such as those that have been designed for handling and processing classified governmental (e.g., military) information. One type of security mechanism that may be implemented is auditing of operating system routines (which may be referred to as “events”) utilized by applications and/or users. For instance, OSs commonly collect audit data regarding use of an operating system routine that is invoked via a system call (or “syscall”) made by an application. For example, suppose an application makes a system call to open a particular file, an audit program within the operating system may collect such audit data for the system call as the date and time the system call was made, name of file to be opened, and result of system call (e.g., system file opened successfully or failed). Such auditing may be performed as part of the security mechanisms included within the OS, for example. Other security mechanisms may be implemented in addition or in place of such auditing feature. In particular, trusted OSs, including without limitation Hewlett-Packard CMW (compartment mode workstation), Hewlett-Packard Virtual Vault, Sun Trusted Solaris, and SCO CMW, commonly include security mechanisms, such as auditing of at least security relevant events.

As is well known to those of ordinary skill in the art, the central module of an OS is the kernel. Generally, it is the part of the OS that loads first, and it typically remains in main memory. Typically, the kernel is responsible for such tasks as memory management, process and task management, and disk management, as examples. The kernel of an OS is often responsible for much of the security measures provided by such OS.

The manner in which security measures are implemented within an OS often creates difficulty/complexity for a system administrator in managing a system, including performing such tasks as adding new applications to the system, etcetera. That is, system administrators are often relied upon for properly configuring system resources and/or security mechanisms in a proper/secure manner. For example, the applications that form electronic services are in general sophisticated and contain many lines of code which will often have one or more bugs in it, thereby making the applications more vulnerable to attack. When an electronic service is offered on the Internet, it is exposed to a large population of potential attackers capable of probing the service for vulnerabilities and, as a result of such bugs, there have been known to be security violations. Once an application has been compromised (for example, by a buffer overflow attack), it can be exploited in several different ways by an attacker to breach the security of the system.

Increasingly, single machines are being used to host multiple services concurrently (e.g. ISP, ASP, xSP service provision), and it is therefore becoming increasingly important that not only is the security of the host platform protected from application compromise attacks, but also that the applications are adequately protected from each other in the event of an attack.

One of the most effective ways of protecting against application compromise at the OS level is by means of kernel-enforced controls, because the controls implemented in the kernel cannot be overridden or subverted from user space by any application or user. Typically, the controls apply to all applications irrespective of the degree of and/or desired secureness of each individual application code. Accordingly, the controls may be unnecessarily utilized in some instances (may overprotect certain applications).

Generally, two basic security goals can be identified as being desired at the system level in order to adequately protect against application compromise and its effects. First, applications should be protected against attack to the greatest extent possible. For example, exposed interfaces to the applications should be as narrow as possible and access to such interfaces should be well controlled. Second, the amount of damage that a compromised application can do to the system should be limited to the greatest possible extent.

The above two requirements may be achieved by use of “containment.” In general, an application is contained if it has strict controls placed on which resources it can access and what type of access it has, even when the application has been compromised. Containment also protects an application from external attack and interference. Thus, the containment functionality has the potential to at least mitigate many of the potential exploitative actions of an attacker.

The most common attacks following the compromise of an application can be roughly categorized as one of four types, as follows (although the consequences of a particular attack may be a combination of any or all of these):

1. Misuse of privilege to gain direct access to protected system resources. If an application is running with special privileges (e.g. an application running as root on a standard Unix operating system), then an attacker can attempt to use that privilege in unintended ways. For example, the attacker could use that privilege to gain access to protected operating resources or interfere with other applications running on the same machine.

2. Subversion of application enforced access controls. This type of attack gains access to legitimate resources (i.e. resources that are intended to be exposed by the application) but in an unauthorized manner. For example, a web server which enforces access control on its content before it serves it, is one application susceptible to this type of attack. Since the web server has uncontrolled direct access to the content, then so does an attacker who gains control of the web server.

3. Supply of false security decision making information. This type of attack is usually an indirect attack in which the compromised application is usually a support service (such as an authorization service) as opposed to the main service. The compromised security service can then be used to supply false or forged information, thereby enabling an attacker to gain access to the main service. Thus, this is another way in which an attacker can gain unauthorized access to resources legitimately exposed by the application.

4. Illegitimate use of unprotected system resources. An attacker gains access to local resources of the machine which are not protected but nevertheless would not normally be exposed by the application. Typically, such local resources would then be used to launch further attacks. For example, an attacker may gain shell access to the hosting system and, from there, staged attacks could then be launched on other applications on the machine or across the network.

With containment, misuse of privilege to gain direct access to protected system resources has much less serious consequences than without containment, because even if an attacker makes use of an application privilege, the resources that can be accessed are bounded by what has been made available in the application's container. Similarly, in the case of unprotected resources using containment, access to the network from an application can be blocked or at least very tightly controlled. With regard to the supply of false security decision making information, containment mitigates the potential damage caused by ensuring that the only access to support services is from legitimate clients, i.e. the application services, thereby limiting the exposure of applications to attack.

Mitigation or prevention of the second type of attack, i.e. subversion of application enforced access controls, is usually achieved at the application design, or at least configuration level. However, using containment, it can be arranged that access to protected resources from a large untrusted application (such as a web server) must go through a smaller, more trustworthy application.

Thus, the use of containment in an operating system effectively increases the security of the applications and limits any damage which may be caused by an attacker in the event that an application is compromised. Referring to FIG. 2, there is illustrated an exemplary architecture 200 for multi-service hosting on an operating system with the containment functionality. Containment is used in the illustrated example to ensure that applications (shown as Service 0, Service 1, . . . , Service N) are kept separated from each other and critical system resources. An application cannot interfere with the processing of another application or obtain access to its (possibly sensitive) data. Containment is used to ensure that only the interfaces (input and output) that a particular application needs to function are exposed by the operating system, thereby limiting the scope for attack on a particular application and also the amount of damage that can be done should the application be compromised. Thus, containment helps to preserve the overall integrity of the hosting platform.

Kernel-enforced containment mechanisms in OSs have been available for several years, typically in OSs designed for handling and processing classified (military) information. Such OSs are often called “Trusted Operating Systems.” The containment functionality is usually achieved through a combination of Mandatory Access controls (MAC), and privileges. MAC protection schemes enforce a particular policy of access control to the system resources such as files, processes and network connections. This policy is enforced by the kernel and cannot be overridden by a user or compromised application.

The complexity/difficulty incurred by a system administrator in managing a system, including management of security mechanisms, such as containment, is generally increased by the tools/techniques available to a system administrator for managing security mechanisms (e.g., for manipulating security mechanism configurations). That is, a system administrator is often required to interact with relatively complex and/or user-unfriendly interfaces for configuring system resources and security mechanisms of an OS. Further, techniques for configuring security mechanisms are generally inefficient, requiring an undesirably large amount of time and effort for a system administrator to perform the tasks necessary for configuring (e.g., manipulating) security mechanisms, such as those for implementing containment within a system.

### SUMMARY OF THE INVENTION

According to one embodiment, a method of administering a processor-based system is disclosed, which comprises implementing at least one compartment for containing at least one process, and providing at least one operating system command-line utility executable to manipulate the compartment(s). According to another embodiment, a system is disclosed that comprises at least one processor, and an operating system that implements at least one compartment to which at least one process executable on the system can be associated. The system further comprises at least one configuration file defining the compartment(s), and means for performing management of the compartment(s) without requiring that a user edit the configuration file(s) in which such compartment(s) are defined. Yet another embodiment provides a computer-readable medium including instructions executable by a processor, wherein such computer-readable medium comprises a library of software functions for managing at least one compartment implemented by an operating system. Such library of software functions includes at least one command-line utility executable to manipulate the compartment(s).

### BRIEF DESCRIPTION OF THE DRAWING

FIG. 1 shows an exemplary prior art computing system, which includes an operating system;

FIG. 2 shows a schematic illustration of an exemplary architecture for multi-service hosting on an operating system implementing containment functionality;

FIG. 3 shows an exemplary schematic illustration of an OS implementation of compartments is shown;

FIG. 4 shows a schematic illustration of an exemplary architecture of a trusted Linux host operating system which may implement compartments, wherein various embodiments of the present invention may be implemented within such exemplary architecture;

FIG. 5 shows an example of utilizing compartments within an OS according to the exemplary implementation of FIG. 4;

FIG. 6 shows schematically the effect of the following rule in an exemplary OS implementation: HOST* ->COMPARTMENT×METHOD TCP PORT 80;

FIG. 7 shows schematically an exemplary configuration of Apache and two Tomcat Java Vms;

FIG. 8 shows schematically an exemplary trusted gateway system;

FIG. 9 shows an exemplary compartment management flow of a typical prior art technique for managing compartments through editing of a configuration file and re-booting the system;

FIG. 10 shows an exemplary compartment management flow according to at least one embodiment of the present invention;

FIG. 11 shows an exemplary operational flow for creating a compartment and then renaming it in accordance with one embodiment of the present invention;

FIG. 12 shows an exemplary operational flow for changing from one compartment to another in accordance with one embodiment of the present invention; and

FIG. 13 shows an exemplary operational flow that utilizes a compartment management utility to change to a different compartment and execute a command therein in accordance with an embodiment of the present invention.

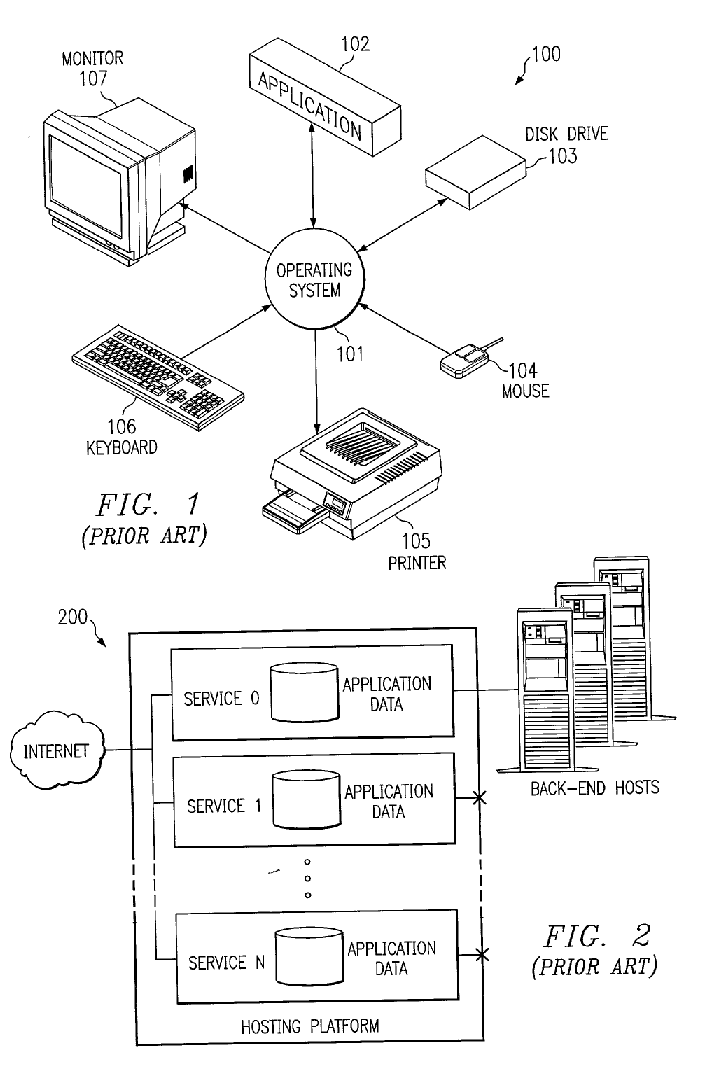

### DETAILED DESCRIPTION

As described above, containment is an effective security mechanism to implement within a system. As described in greater detail hereafter, containment functionality may be implemented within a system by utilizing compartments within the system. In general, compartments refer to groups of processes or threads which are limited to accessing certain subsets of system resources of a computer system. Thus, compartments are semi-isolated portions of a system. For example, an operating system for supporting a plurality of processes (e.g., applications) may be implemented on a system, wherein at least some of the processes are provided with a label or tag, each label or tag being indicative of a logically protected computing environment or “compartment.” Each process having the same label or tag may belong to the same compartment. In certain implementations, containment functionality can be provided by mandatory protection of processes, files and network resources, with the principal concept being based on the compartment. Services and processes (e.g., applications) on the system may be run within separate compartments. Processes within each compartment may only have direct access to the resources in that compartment. Access to other resources, whether local or remote, may be allowed only via well-controlled communication interfaces. Exemplary implementations of compartments within a system are described in further detail hereafter.

According to various embodiments of the present invention, an efficient and user-friendly manner of managing (e.g., manipulating) compartments within an OS is disclosed. More specifically, utilities, such as command-line utilities, are provided that enable commands to be executed from the user-space of an OS to manage compartments. According to at least one embodiment, command-line utilities are provided that enable commands to be executed to dynamically manipulate compartments and/or rules defining the containment of such compartments.

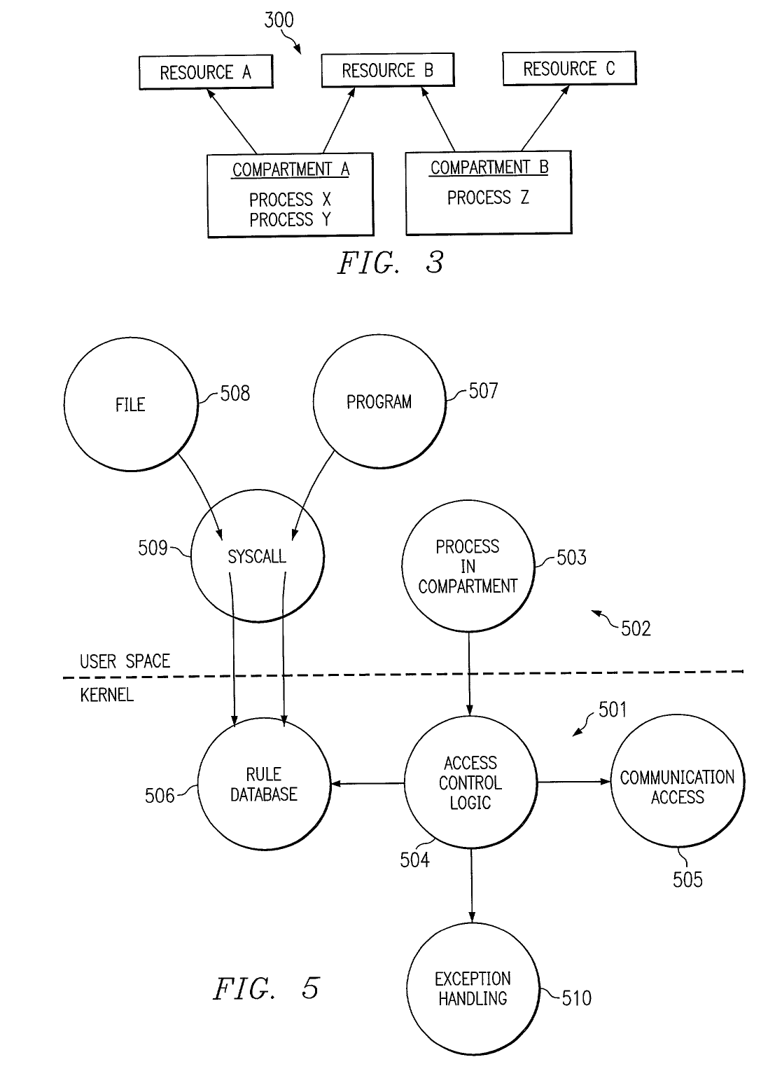

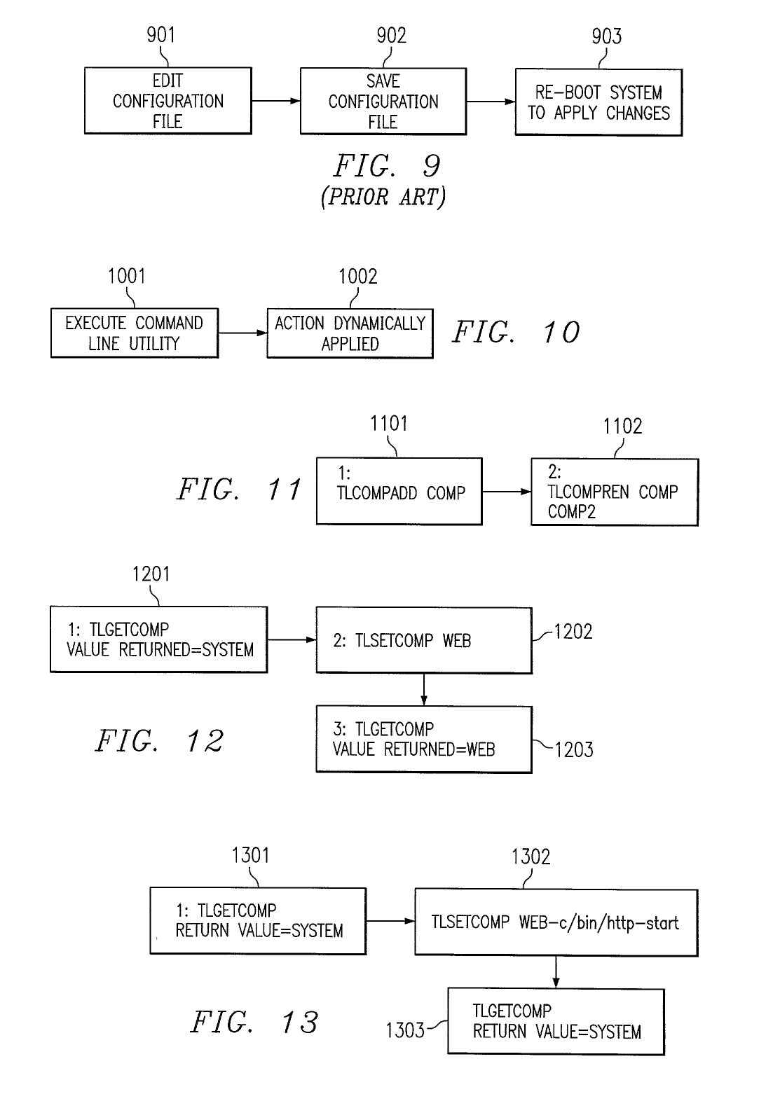

To have a greater appreciation of the present invention, it is appropriate for the reader to understand utilization of compartments within an OS. Accordingly, an exemplary OS that implements compartments therein, as well as exemplary compartment arrangements, are described hereafter in conjunction with FIGS. 3-8. While a specific OS architecture and technique for implementing compartments within such OS is described hereafter, it should be understood that the described OS and compartment implementations are intended only as an example to aid the reader's comprehension of certain aspects of the present invention, and the present invention is therefore not intended to be limited to the specific OS and/or compartment implementations described hereafter. Rather, any OS and any method for implementing compartments that is now known or later discovered are intended to be within the scope of the present invention, which is defined by the appended claims. After providing an example of an OS architecture implementing compartments, techniques for managing (e.g., manipulating) such compartments are described. A prior art technique for managing compartments through editing of a configuration file and re-booting the system is described in conjunction with FIG. 9. Exemplary techniques for managing (e.g., manipulating) compartments utilizing utilities according to certain embodiments of the present invention are then described in conjunction with FIGS. 10-13.

I. Exemplary OS Architecture and Compartment Implementation

According to one exemplary OS in which various embodiments of the present invention may be implemented, containment functionality is achieved by means of kernel-level mandatory protection of processes, files and network resources. Various types of mandatory controls may be utilized, such as those of traditional trusted OSs. Often, the key concept of a trusted OS is the “compartment”, and various services and processes (e.g., applications) on a system may be executed within separate compartments. Turning to FIG. 3, an exemplary schematic representation of an OS implementation of compartments is shown, which provides a very simplistic example of the concept of compartments. As shown, system 300 may comprise an OS executing thereon which implements two compartments, shown as compartment A and compartment B. In the example of FIG. 3, processes X and Y are contained in compartment A and process Z is contained in compartment B. System 300 may comprise various resources, shown as resource A, resource B, and resource C in FIG. 3, and the compartments may be implemented to designate those resources which the processes contained therein are to be allowed access. Such resources A, B, and C may comprise network interfaces, processes, files, and/or other types of system resources. According to certain implementations, any number of system resources can be organized according to compartment access control. For example, system resources associated with TCP/IP networking, routing tables, routing caches, shared memory, message queues, semaphores, process/thread handling, and user-id (UID) handling can be limited by utilizing compartments.

In the example shown in FIG. 3, processes X and Y contained in compartment A have access to resource A and resource B, but not resource C. Further, process Z contained in compartment B has access to resource B and resource C, but not resource A. Thus, compartments may be utilized as a security mechanism that protects applications against attack and limits the amount of damage that may result from a compromised process to the system, as a compromised process within one compartment will have its access restricted to those resources to which the compartment is allowed access.

According to one exemplary OS implementation, relatively simple mandatory access controls and process labelling may be used to create the concept of a compartment. In the following exemplary implementation of a trusted OS, each process within the system is allocated a label, and processes having the same label belong to the same compartment. Kernel-level mandatory checks are enforced to ensure that processes from one compartment cannot interfere with processes from another compartment. The mandatory access controls are relatively simple in the sense that labels either match or they do not. Further, in this example, there is no hierarchical ordering of labels within the system, as there is in some known trusted operating systems. Unlike traditional trusted OSs, in this example, labels are not used to directly control access to the main filesystem. Instead, filesystem protection is achieved by associating a different section of the main filesystem with each compartment. Each such section of the file system is a “chroot” of the main filesystem, and processes running within any compartment only have access to the section of filesystem which is associated with that compartment.

As used herein, “chroot” refers to a command for changing the active root directory. That is, chroot is a command that executes to change a user's active root directory. For example, in a typical Unix system, the root directory is indicated as “/”. Thus, the command “cd/” will normally execute to change to the root directory of the filesystem. The chroot command may be executed to change a user's active root directory. For instance, the command “chroot/home” changes a user's active root directory to “/home”. Thereafter, executing the command “cd/” results in changing to the “/home” directory rather than “/”, as “/home” is now the user's active root directory. As a further example, the chroot command may be utilized to specify a particular compartment as the active root directory. For instance, the command “chroot/compt/FOO” changes the active root directory to compartment FOO. Accordingly, as the “cd/” executes to change to the active root directory (which may be changed by the chroot command), the chroot command may be utilized as a further security mechanism. For instance, the chroot command may be utilized to effectively prevent a user (or a process) from escaping the active root directory specified by the chroot command. That is, for example, a user (or process) may not escape the active root directory specified by the chroot command (e.g., compartment FOO) to the actual root directory (“/”) of the system. Once the active directory of a user (or process) has been changed via the chroot command, it is said to have been chroot-ed. Accordingly, via kernel controls, the ability of a process to transition to root from within a compartment is removed in this exemplary implementation so that the chroot cannot be escaped. This exemplary implementation provides the ability to make at least selected files within chroot immutable.

Also in this exemplary OS architecture, flexible communication paths between compartments and network resources are provided via narrow, kernel-level controlled interfaces to TCP/UDP plus most IPC mechanisms. Access to these communication interfaces is governed by rules, which may be specified by the security administrator on a “per compartment” basis. Thus, unlike in traditional trusted operating systems, in this exemplary implementation it is not necessary to override the mandatory access controls with privilege or resort to the use of user-level trusted proxies to allow communication between compartments and network resources.

The exemplary implementation provides a trusted OS which offers containment, but also has enough flexibility to make application integration relatively straightforward, thereby reducing the management overhead and the inconvenience of deploying and running a trusted operating system that is often associated with traditional trusted OSs. Again, while a specific example of architecture and implementation utilizing compartments is described herein, which constitutes a preferred architecture and implementation in which embodiments of the present invention may be implemented, it should be understood that any OS architecture and technique for implementing compartments now known (e.g., traditional trusted OSs) or later discovered are intended to be within the scope of the present invention, and certain embodiments of the present invention may be implemented in any such OS architecture.

The OS architecture and implementation of a specific example for implementing compartments will now be described in greater detail. In the following description, a trusted Linux OS is described in detail, which system is realized by modification to the base Linux kernel to support containment of user-level services, such as HTTP-servers. However, it will be apparent to a person skilled in the art that the principles described in conjunction with such trusted Linux OS may be applied to other types of OSs to achieve the same or similar effects.

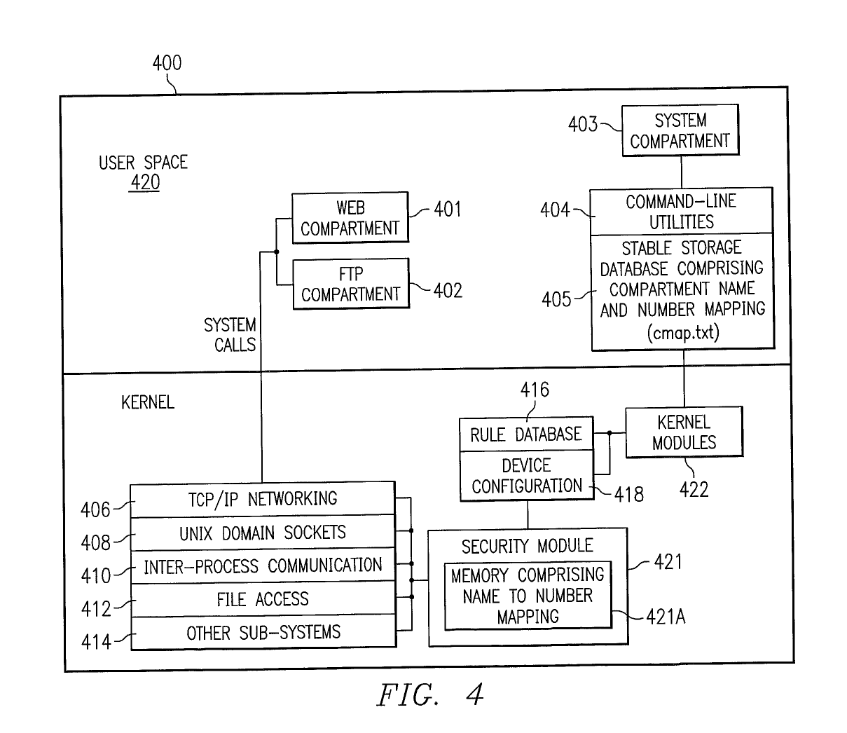

Referring now to FIG. 4, there is illustrated an exemplary architecture of a trusted Linux host OS, which implements compartments to provide containment. System 400 includes a plurality of compartments. In this example, WEB compartment 401, FTP compartment 402, and SYSTEM compartment 403 are shown. Each compartment may be associated with various executing processes or threads. Thus, with reference to FIG. 4, a base Linux kernel 400 generally comprises TCP/IP Networking means 406, UNIX domain sockets 408, inter-process communication means 410 (e.g., a Sys V IPC means), file access module 412, and other subsystems 408. The trusted Linux OS additionally comprises kernel extensions 415 in the form of a security module 421, a device configuration module 418, a rule database 416 and kernel modules 422. As shown, at least some of the Linux kernel subsystems 406,408,410,412, and 414 have been modified to make call outs to the kernel- level security module 421. In this exemplary implementation, the security module 421 makes access control decisions and is responsible for enforcing the concept of a compartment, thereby providing containment. Such exemplary OS architecture in which embodiments of the present invention may be implemented is further described in concurrently filed and commonly assigned U.S. patent application Ser. No. ______ entitled “SYSTEM AND METHOD FOR FILE SYSTEM MANDATORY ACCESS CONTROL,” the disclosure of which has been incorporated herein by reference.

Security module 421 additionally consults rule database 416 when making a decision. Rule database 416 contains information about allowable communication paths between compartments, thereby providing narrow, well-controlled interfaces into and out of a compartment. Thus, the processes of the compartments are limited to accessing system resources according to the rules stored in rule database 416. Rule database 416 may comprise separate tables for TCP/IP networking resource rules and for file system resource rules. Also, the various components can be stored in different locations. For example, TCP/IP resource rules may be stored in random access memory, while file system resource rules may be stored on the file system. FIG. 4 also illustrates how kernel extensions 415 are administered from user space 420 via a series of custom system calls. As described further below, such custom system calls may include: some to manipulate the rule table 416 and others to run processes in particular compartments and configure network interfaces.

As described in greater detail below, system compartment 403 may include processes that facilitate command-line utilities 404 to modify the compartments or rules associated with such compartments. According to various embodiments of the present invention, command-line utilities 404 may include commands for managing compartments (e.g., manipulating compartments and/or compartment rules). As shown in the exemplary system of FIG. 4, stable storage database 405 may be implemented in the user space, which includes information identifying compartment names and corresponding number mapping for each compartment (e.g., in file “cmap.txt”). Thus, user-friendly names may be assigned to each compartment, and each compartment may also have mapped thereto a respective number that is used for internal processing by system 400. Further, security module 421 preferably includes memory 421A comprising compartment name to number mapping that enables security module 421 to identify the corresponding rules in rule database 416 that are applicable to a particular compartment requesting access to system resources.

In operation, each of the kernel modules of system 400 advantageously interacts with security module 421. Security module 421 enforces the compartment scheme to prevent unauthorized access to system resources. Specifically, security module 421 utilizes device configuration module 418 and rule database 416 to facilitate compartment limitations. Security module 421 is capable of determining which resources are available to system 400 via device configuration module 418. Security module 421 further receives identification of a compartment and identification of a system resource to be accessed from a routine of a kernel module. Security module 421 searches rule database 416 to locate an applicable rule. Security module 421 permits or disallows access upon the basis of an applicable rule or upon the basis of a default rule if no applicable rule is located.

Turning briefly to FIG. 5, an example of utilizing compartments within an operating system according to an exemplary implementation is shown. As shown, system call (syscall) commands 509 may be utilized to enable a user to manipulate rules within rule engine 506 (executing in kernel 501) from user space 502. As an example, a program 507 or file 508 may execute such syscall commands 509 to implement the desired rules in rule engine 506 to define the containment of compartment(s). The example of FIG. 5 further includes process 503, which is associated with a particular compartment. Process 503 executes code in user space 502, which is a hardware-enforced operating mode that limits the operations of process 503. Process 503 may include code that is operable to attempt to access a protected resource (e.g., opening a certain file) according to a compartment scheme, may request access to a particular resource. That is, process 503 requests (e.g., via a customized syscall) to have communication access 505 to a desired resource. Access control logic 504 executes in kernel 501 to access rule engine 506 in order to determine whether process 503 is to be granted the access requested. More specifically, access control logic 504 receives a compartment identifier or tag of process 503 and utilizes such compartment identifier to search rule database 506 to determine if the compartment associated with process 503 is permitted access to the particular resource. According to at least one implementation, a hash table may be utilized for performing rule lookup. Depending on the intended use of the system, such internal hash tables can be configured in such a way that the inserted rules are on average one level deep within each hash-bucket, which makes the rule-lookup routines behave in the order of O(1). Accordingly, rule-lookup may be performed in a relatively quick, efficient manner. Depending on the rules defined for the compartment in which process 503 is contained, access control logic 504 may grant communication access 505 or may deny such communication access to process 503. If access is denied, access control logic 504 transfers processing control to exception handling module 510, which may return an exception (e.g., an error message) to process 503 and/or it may terminate operations of process 503.

Returning to FIG. 4, various user-space services may be implemented within the exemplary architecture shown, for which compartments may be utilized. User-space services, such as the web servers shown in FIG. 4, are run unmodified on the platform, but have a compartment label associated with them via the command-line interface to the security extensions. Security module 421 is then responsible for applying the mandatory access controls to the user-space services based on their applied compartment label. It will be appreciated, therefore, that the user-space services can thus be contained without having to modify those services in the exemplary implementation shown.

The exemplary implementation of FIG. 4 employs a kernel module (e.g., security module 421), which may be named “lns,” to implement custom system calls that enable the insertion/deletion of rules and other functions such as labeling of network interfaces. Such lns module implements various interfaces via custom system calls to enable:

1. A calling process to switch compartments.

2. Individual network interfaces to be assigned a compartment number.

3. Utility functions, such as process listing with compartment numbers and the logging of activity to kernel-level security checks.

According to certain embodiments of the present invention implemented in this exemplary architecture, the main client of the lns module is the tlutils collection of command-line utilities described more fully below.

The lns module implements an interface to add/delete rules in the kernel via custom system calls. It performs the translation between higher-level simplified rules into primitive forms more readily understood by kernel lookup routines. (This module is called by the tlutils user-level utilities to manipulate rules within the kernel.)

In this exemplary implementation, modifications have been made to the standard Linux kernel sources so as to introduce a tag on various data types and for the addition of access-control checks made around such tagged data types. Each tagged data type contains an additional struct csecinfo data-member which is used to hold a compartment number. It is envisaged that the tagged data types could be extended to hold other security attributes. In general, the addition of this data-member is usually performed at the very end of a data-structure to avoid issues arising relating to the common practice casting pointers between two or more differently named structures which begin with common entries.

The net effect of tagging individual kernel resources is to very simply implement a compartmented system where processes and the data they generate/consume are isolated from one another. In this exemplary implementation, such isolation is not intended to be strict in the sense that many covert channels exist. The isolation in this exemplary implementation is simply intended to protect obvious forms of conflict and/or interaction between logically different groups of processes.

In at least one implementation, compartments may be sealed against assumption of root-identity. That is, individual compartments may optionally be registered as “sealed” to protect against processes in that compartment from successfully calling setuid(0) and related system calls, such as setuid(0), and also from executing any SUID-root binaries. This may be used for externally-accessible services which may in general be vulnerable to buffer-overflow attacks leading to the execution of malicious code, as an example. If such services are constrained to being initially run as a pseudo-user (non-root) and if the compartment it executes in is sealed, then any attempt to assume the root-identity either by buffer-overflow attacks and/or execution of foreign instructions will fail. Note that any existing processes running as root will continue to do so.

Various types of services may be implemented within compartments. The kernel modifications described above serve to support the hosting of individual user-level services in a protected compartment. In addition to this, the layout, location and conventions used in adding or removing services in this exemplary embodiment of the invention will now be described.

Individual services may be allocated a compartment each. However, what an end-user perceives as a service may actually end up using several compartments. An example would be the use of a compartment to host an externally-accessible Web-server with a narrow interface to another compartment hosting a trusted gateway agent for the execution of CGI-binaries in their own individual compartments. In this case, at least three compartments may be utilized:

one for the web-server processes;

one for the trusted gateway agent which executes CGI-binaries; and

as many compartments as are needed to properly categorize each CGI binary, as the trusted gateway will fork/exec CGI-binaries in their configured compartments.

In this exemplary implementation, every compartment has a name and resides as a chroot-able environment under/compt. Examples used in this implementation include:

| Location | Description |
|---|---|
| /compt/admin | Admin HTTP-server |
| /compt/omailout | Externally visible HTTP-server hosting |
| | OpenMail server processes |
| /compt/omailin | Internal compartment hosting OpenMail |
| | server processes |
| /compt/web1 | Externally visible HTTP-server |
| /compt/web1mcga | Internal Trusted gateway agent for Web1's |
| | CGI-binaries |

In addition, the following subdirectories also exist:

1. /bin—various scripts and command-line utilities for managing compartments may be installed in /bin in accordance with certain implementations of the present invention; and

2. /etc/tlinux/rules—files containing rules for every registered compartment on the system may be located within /etc/tlinux/rules in accordance with certain implementations of the present invention.

To support the generic starting/stopping of a compartment in this exemplary implementation, each compartment preferably conforms to a few basic characteristics:

1. be chroot-able under its compartment location /compt/<name>. However, it is not essential that a compartment have a chroot in order to start. Rather, this provides an added security feature that is not required in all implementations of the present invention.

2. provide /etc/tlinux/init/<name>/startup and /etc/tlinux/init/<name>/shutdown to start/stop the compartment identified by <name>.

3. startup and shutdown scripts are responsible for inserting rules, creating routing-tables, mounting filesystems (e.g., /proc)and other per-service initialization steps.

In general, if the compartment is to be externally visible, the processes in that compartment should not run as root by default and the compartment should be “sealed” after initialization. Sometimes this is not possible due to the nature of a legacy application being integrated/ported, in which case it is desirable to remove as many capabilities as possible in order to prevent the processes from escaping the chroot-jail, e.g. cap_mknod.

Since compartments may exist as chroot-ed environments under the /compt directory, application-integration may require the usual techniques used for ensuring that they work in a chroot-ed environment. A common technique is to prepare a cpio-archive of a minimally running compartment, containing a minimal RPM-database of installed software. It is usual to install the desired application on top of this and, in the case of applications in the form of RPM's, the following steps could be performed:

root@tlinux# chroot/compt/app 1

root@tlinux# rpm -install<RPM-package-filename>

root@tlinux# [Change configuration files as required, e.g. httpd.conf]

root@tlinux# [Create startup/shutdown scripts in /compt/app 1]

The latter few steps may be integrated into the RPM-install phase. Reductions in disk-space can be achieved by inspection: selectively uninstalling unused packages via the rpm-command. Additional entries in the compartment's /dev-directory may be created if required, but /dev is normally left substantially bare in most cases. Further automation may be achieved by providing a Web-based interface to the above-described process to supply all of the necessary parameters for each type of application to be installed. No changes to the compiled binaries are needed in general, unless it is required to install compartment-aware variants of such applications.

Once rules are in place (e.g., in rule database 416 of FIG. 4) to define the containment of compartments, such compartments may be utilized by the OS to perform security checks. In this exemplary implementation, there exists a function “cnet_chk_attr( )” that implements a yes/no security check for the subsystems which are protected in the kernel. Calls to this function are made at the appropriate points in the kernel sources to implement the compartmented behavior required. This function is predicated on the subsystem concerned and may implement slightly different defaults or rule-conventions depending on the subsystem of the operation being queried at that time. For example, most subsystems implement a simple partitioning where only objects/resources having exactly the same compartment number result in a positive return value. However, in certain cases, the use of a no-privilege compartment 0 and/or a wildcard compartment -1L can be used, e.g. compartment 0 as a default “sandbox” for unclassified resources/services; a wildcard compartment for supervisory purposes, like listing all processes on the subsystem prior to shutting down.

As shown in the example of FIG. 5, at appropriate points in the kernel, access-control checks are performed (by access control logic 504). More specifically, in this exemplary implementation, such access-control checks are performed through the use of hooks to a dynamically loadable security-module 421 (FIG. 4) that consults a table of rules (rule database 416 of FIG. 4) indicating which compartments are allowed to access the resources of another compartment. This occurs transparently to the running applications.

Each security check may consult a table of rules. Each rule may have the form:

source ->destination method m [attr] [netdev n]

where:

source/destination is one of:

COMPARTMENT (a named compartment);

HOST (a fixed IPv4 address);

NETWORK (an IPv4 subnet);

m: supported kernel mechanism, e.g. tcp, udp, msg (message queues), shm (shared-memory), etcetera;

attr: attributes further qualifying the method m; or

n: a named network-interface if applicable, e.g. eth0.

An example of such a rule which allows processes in the compartment named “WEB” to access shared-memory segments, for example using shmat/shmdt( ), from the compartment named “CGI” would look like:

COMPARTMENT: WEB ->COMPARTMENT: CGI METHOD shm

Present also are certain implicit rules, which allow some communications to take place within a compartment, for example, a process might be allowed to see the process identifiers of processes residing in the same compartment. This allows a bare-minimum of functionality within an otherwise unconfigured compartment. An exception is compartment 0, which is relatively unprivileged and where there are more restrictions applied. Compartment 0 may be used to host kernel-level threads (such as the swapper).

In the absence of a rule explicitly allowing a cross-compartment access to take place, all such attempts fail. The net effect of the rules is to enforce mandatory segmentation across individual compartments, except for those which have been explicitly allowed to access another compartment's resources.

The rules are directional in nature, with the effect that they match the connect/accept behavior of TCP socket connections. Consider a rule used to specify allowable incoming HTTP connections of the form:

HOST* ->COMPARTMENT X METHOD TCP PORT 80

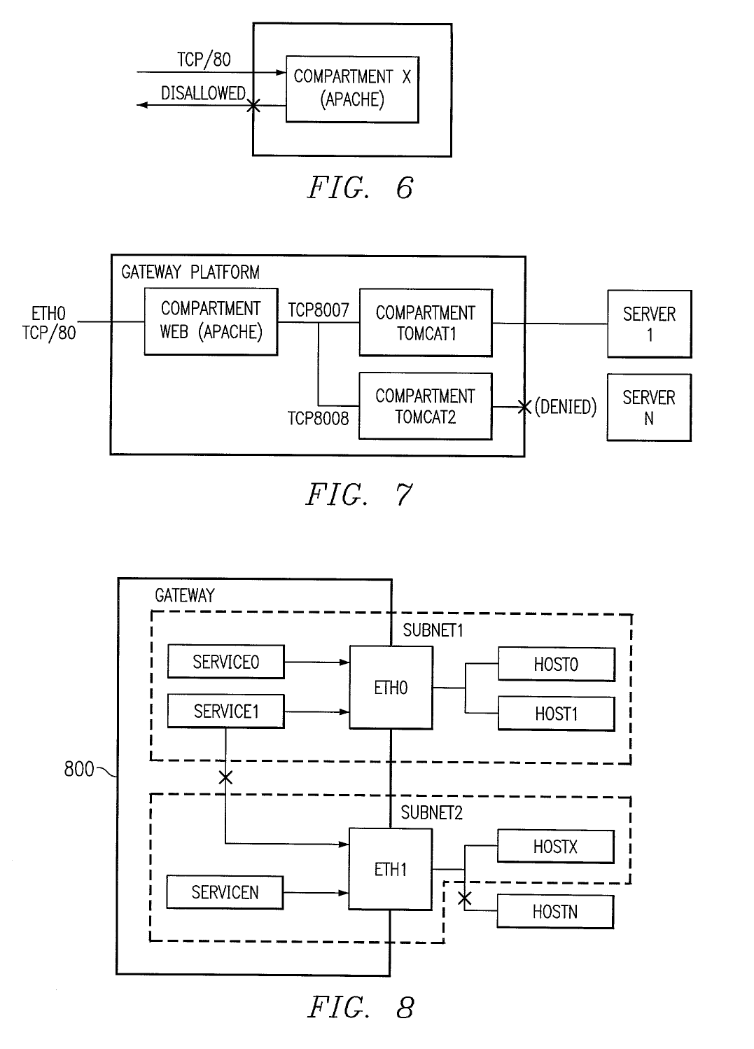

This rule specifies that only incoming TCP connections on port 80 are to be allowed, but not outgoing connections, as is illustrated in the example shown in FIG. 6. The directionality of the rules permits the reverse flow of packets to occur in order to correctly establish the incoming connection without allowing outgoing connections to take place.

The approach described above has a number of advantages. For example, it provides complete control over each supported subsystem and the ability to compile out unsupported ones, for example, hardware-driven card-to-card transfers. Further, this approach provides relatively comprehensive namespace partitioning, without the need to change user-space commands such as ps, netstat, route, ipcs etc. Depending on the compartment that a process is currently in, the list of visible identifiers changes according to what the rules specify. Examples of namespaces include Process-table via/proc, Sys V IPC resource-identifiers, Active, closed and listening sockets (all domains), and Routing table entries.

It shall be appreciated that the system of FIG. 4 is intended only as an example. The present invention is not limited to any particular compartment or containment scheme.

Specifically, numerous approaches can be utilized to prevent processes associated with a compartment from accessing system resources. For example, access control can be implemented at the user-level via several techniques. A strace( ) mechanism can be utilized to trace each system-call of a given process. The strace( ) mechanism examines each system call and its arguments. The strace( ) mechanism either allows or disallows the system call according to rules defined in a rule database. System-call wrapping can be utilized. In system call wrapping, wrapper functions using a dynamically linked shared library examine system calls and arguments. The wrapper functions also either allow or disallow system calls according to rules defined in a rule database. User-level authorization servers can be utilized to control access to system resources. User-level authorization servers can control access to system resources by providing a controlled data channel to the kernel.

One application of the above-described OS architecture is to provide a secure web server platform with support for the contained execution of arbitrary CGI-binaries and with any non-HTTP related processing (e.g. Java servlets) being partitioned into separate compartments, each with the bare minimum of rules required for their operation. This is a more specific configuration than the general scenario of:

1. Secure gateway systems which host a variety of services, such as DNS, Sendmail, etc. Containment or compartmentalization in such systems could be used to reduce the potential for conflict between services and to control the visibility of back-end hosts on a per-service basis.

2. Clustered front-ends (typically HTTP) to multi-tiered back-ends, including intermediate application servers. Compartmentalization in such systems has the desired effect of factoring out as much code as possible that is directly accessible by external clients.

Returning now to FIG. 4, system 400 may comprise a web-server platform, for example, wherein each web-server may be placed in its own compartment, such as WEB compartment 401. The following description is intended to illustrate how the exemplary implementation may be used to compartmentalize a setup comprising an externally facing Apache Web-server configured to delegate the handling of Java servlets or the serving of JSP files to two separate instances Jakarta/Tomcat, each running in its own compartment. By default, each compartment uses a chroot-ed filesystem so as not to interfere with the other filesystems.

FIG. 7 illustrates schematically the Apache processes residing in one compartment (WEB). This compartment is externally accessible using the rule:

HOST* ->COMPARTMENT WEB METHOD TCP PORT 80 NETDEV eth0

The presence of the NETDEV component in the rule specifies the network-interfaces which Apache is allowed to use. This is useful for restricting Apache to using only the external interface on dual/multi-homed gateway systems. This is intended to prevent a compromised instance of Apache being used to launch attacks on back-end networks through internally facing network interfaces. The WEB compartment is allowed to communicate to two separate instances of Jakarta/Tomcat (TOMCAT1 and TOMCAT2) via two rules which take the form:

COMPARTMENT: WEB ->COMPARTMENT: TOMCAT1 METHOD TCP PORT 8007

COMPARTMENT:WEB ->COMPARTMENT TOMCAT2 METHOD TCP PORT 8008

The servlets in TOMCAT1 are allowed to access a back-end host called Server1 using this rule:

COMPARTMENT:TOMCAT1 ->HOST:SERVER1 METHOD TCP . . .

However, TOMCAT 2 is not allowed to access any back-end hosts at all—which is reflected by the absence of any additional rules. The kernel will deny any such attempt from TOMCAT2. This allows one to selectively alter the view of a back-end network depending on which services are being hosted, and to restrict the visibility of back-end hosts on a per-compartment basis.

It is worth noting that the above four rules are all that is needed for this exemplary configuration. In the absence of any other rules, the servlets executing in the Java VM cannot initiate outgoing connections; in particular, it cannot be used to launch attacks on the internal back-end network on interface eth 1. In addition, it may not access resources from other compartments (e.g. shared-memory segments, UNIX-domain sockets, etc.), nor be reached directly by remote hosts. In this case, mandatory restrictions have been placed on the behavior of Apache and Jakarta/Tomcat without recompiling or modifying their sources.

It should be understood that compartments may be utilized within a gateway-type system (host with dual-interfaces connected to both internal and external networks). Referring to FIG. 8, a gateway system 800 (connected to both an internal and external network) is shown. The gateway system 800 is hosting multiple types of services Service0, Service1, . . . , ServiceN, each of which is connected to some specified back-end host, Host0, Host1, . . . HostX, HostN, to perform its function, e.g. retrieve records from a back-end database. Many back-end hosts may be present on an internal network at any one time (not all of which are intended to be accessible by the same set of services). It is desired that, if these server-processes are compromised, they should not be able to be used to probe other back-end hosts not originally intended to be used by the services. The exemplary implementation limits the damage an attacker can do by restricting the visibility of hosts on the same network.

As shown in FIG. 8, Service0 and Service1 are only allowed to access the network Subnet1 through the network-interface eth0. Therefore, attempts to access Host0/Host1 succeed because they are Subnet1, but attempts to access Subnet2 via eth1 fail. Further, ServiceN is allowed to access only HostX on eth1. Thus any attempt by ServiceN to access HostN fails, even if HostN is on the same subnet as HostX, and any attempt by ServiceN to access any host on Subnet1 fails. The restrictions can be specified (by rules or routing-tables) by subnet or by specific host, which in turn may also be qualified by a specific subnet.

Thus, in the exemplary implementation described above, access-control checks may be implemented in the kernel/operating system of a gateway system, such that they cannot be bypassed by user-space processes. As further described above, the kernel (of the gateway system) may be provided with means for attaching a tag or label to each running process/thread, the tags/labels indicating notionally which compartment a process belongs to. In certain implementations, such tags may be inherited from a parent process which forks a child. Thus, a service comprising a group of forked children cooperating to share the workload, such as a group of slave Web-server processes, would possess the same tags and be placed in the same “compartment.” The system administrator may specify rules, for example in the form:

Compartment X ->Host Y [using Network Interface Z] or

Compartment X ->Subnet Y [using Network Interface Z]

which allow processes in a named compartment X to access either a host or a subnet Y, optionally restricted by using only the network-interface named Z. Such rules may be stored in a secure configuration file on the gateway system and loaded into the kernel/operating system at system startup so that the services which are then started can operate. When services are started, their start-up sequence would specify which compartment they would initially be placed in. In this embodiment, the rules are consulted each time a packet is to be sent from or delivered to Compartment X by placing extra security checks, preferably in the kernel's protocol stack.

In certain implementations, a separate routing-table per-compartment is provided. As with the implementation described above, each process may possess a tag or label (which may be inherited from its parent). Certain named processes start with a designated tag configured by a system administrator. Instead of specifying rules, as described in the above implementation, a set of configuration files may be provided (one for each compartment) which configure the respective compartment's routing-table by inserting the desired routing-table entries. Because the gateway system could contain an un-named number of compartments, each compartment's routing-table is preferably empty by default (i.e. no entries).

The use of routing-tables instead of explicit rules can be achieved because the lack of a matching route is taken to mean that the remote host which is being attempted to be reached is reported to be unreachable. Routes which do match signify acceptance of the attempt to access that remote host. As with the rules in the first exemplary implementation described above, routing-entries can be specified on a per-host (IP-address) or a per-subnet basis. All that is required is to specify such routing-entries on a per-compartment basis in order to achieve the same functionality as in the first exemplary implementation.

II. Compartment Management According to Various Embodiments of the Invention

The above has provided an overview of an exemplary OS architecture for implementing compartments. It should be understood that certain embodiments of the present invention may be implemented within any OS and compartment architecture, and is therefore not limited to the exemplary implementation described above.

Given that compartments provide an important security mechanism within trusted OSs, it is desirable to have an efficient and user-friendly mechanism for managing such compartments. For instance, from time to time it may be desirable for a user, such as a system administrator, to manipulate compartments, e.g., add a new compartment, remove a compartment, rename a compartment, etcetera. Additionally, it may be desirable for a user to manipulate rules that define the containment of compartments. Such manipulation of compartments and manipulation of rules defining containment of such compartments are intended to be encompassed by the term “compartment management,” as used herein.

Various problems exist with traditional techniques for managing compartments. A prior art technique for managing compartments is shown in FIG. 9. Compartments are traditionally defined in a configuration file that the OS utilizes upon boot-up of a computer system to determine the compartments available within such OS. As shown, in FIG. 9, management of compartments in prior art systems to, for example, manipulate a compartment requires that a user (e.g., system administrator) edit the configuration file in which compartments are defined (step 901). Similarly, manipulating rules defining the containment of a compartment requires that a user edit the configuration file in which such rules are provided. That is, in step 901 a user may utilize a text editor to view and edit a configuration file in a manner to manipulate compartments and/or rules.

Of course, to even edit the configuration file, the proper configuration file must first be determined, located within the system files, and opened for editing. Once the configuration file is opened for editing, the user may edit the file (e.g., add and/or remove text within the file) to manipulate compartments and/or rules. For example, to rename a compartment, the user would have to search through the configuration file, which may comprise a very large amount of text therein, and edit the appropriate portions of the configuration file in order to change the name of a compartment. As another example, to add a compartment, the user would have to edit the configuration file by inserting appropriate text therein for defining a new compartment to be created. Once the user edits the configuration file, the edits made to the configuration file must be saved in step 902. For the changes made to the configuration file to be applied within the system, a re-boot of the system is typically required (step 903). More specifically, systems typically access the configuration file upon boot-up, and changes made during system runtime to the configuration file are not applied within the system until it is re-booted.

The above-described method of managing compartments is problematic for several reasons. First, such prior art compartment management technique requires that a user edit a configuration file. Given the size and amount of information that may be included within such configuration file, great complexity/difficulty may be associated with properly editing the configuration file to achieve a desired result. Additionally, editing a configuration file is an inefficient technique of manipulating compartments, as a user is required to determine the appropriate configuration file to be edited, open the file, and properly edit the file (which may comprise a large amount of information therein that the user may be required to parse through to ensure that it is properly edited to achieve the intended result). Further, such prior art technique typically requires that the system be re-booted in order to have the changes made to the configuration file be applied to the system's operation. In addition to the inefficiency and undesirable interruption resulting from such a system re-boot, errors made in editing the configuration file may not be discovered until such a re-boot is performed. Further, if an encountered error within the configuration file is fatal to the point that the system will not re-boot, then a recovery of the system may be required to be performed by re-loading the entire OS.

Embodiments of the present invention alleviate the requirement of editing a configuration file for managing compartments by providing utilities that may be utilized within the user-space of an OS (e.g., command-line utilities) that enable management of compartments. For instance, according to at least one embodiment, command-line utilities are provided that enable a user to manipulate compartments by performing such tasks as creating, renaming, or removing compartments. Similarly, in certain embodiments, rules defining containment of compartments may be manipulated via command-line utilities. Additionally, according to certain embodiments of the present invention, executed utilities enable compartments and rules to be dynamically manipulated. That is, a system re-boot is not required in order to have actions requested through use of the utilities to be applied within the system's operation. FIG. 10 shows an exemplary compartment management flow according to at least one embodiment of the present invention. As shown, to manipulate a compartment and/or rule, a user may execute a command-line utility in step 1001, and the action(s) generated by such utility are dynamically applied to the system's operation in step 1002.

According to one embodiment of the present invention, compartment management utilities are provided, which include a number of command-line tools to create, administrate and remove compartments. An exemplary list of utilities that may be available in at least one embodiment of the present invention, as well as an overview of the functionality performed by each utility, is provided hereafter. It should be understood that the names of the utilities may change in various embodiments without altering their functionality. Thus, the present invention is not intended to be limited to the specific utilities described hereafter, but rather such exemplary utilities are intended as examples that render the disclosure enabling for many other types of compartment management utilities that may be desirable to implement within a given system.

As described in greater detail below, according to various embodiments of the present invention a suite of compartment management utilities are provided. According to certain embodiments, such compartment management utilities comprise command-line utilities, which may be referred to herein as “tl” utilities (e.g., “tlrules” and “tlcomp” utilities described below). Various examples of such utilities for manipulating compartment rules and for manipulating compartments in accordance with embodiments of the present invention are described further below. However, it should be understood that while specific utilities and their functionality are described below, such utilities are intended as examples that render the disclosure enabling for

many other compartment management utilities that may be implemented in a similar fashion.

Exemplary Utilities for Manipulating Compartment Rules

According to at least one embodiment of the present invention, “tlrules” utilities are provided for manipulating compartment rules. Such “tlrules” utilities may comprise command-line utilities for adding, deleting and listing rules. In the exemplary implementation described above with FIG. 4, such tlrules may be implemented as command-line utilities 440 that are executable to manipulate compartment rules (e.g., within rule database 416) via /proc/tlx interface provided by a kernel-loadable module. Rules can either be entered on the command line, or can be read from a text file.

In accordance with the exemplary implementation described above, rules may take the following format:

<rule>::=<source>[<port>]-><destination>[<port>]<method list>
<netdev>

where:
<identifier>== (<compartment>_<host>_<net>) [<port>]
<compartment>==“COMPARTMENT”<comp_name>
<host>==“HOST”<host_name>
<net>==“NET”<ip_addr><netmask>
<net>==“NET”<ip_addr>“/”<bits>
<comp_name>==A valid name of a compartment
<host_name>==A known hostname or IP address
<ip_addr>==An IP address in the form a.b.c.d
<netmask>==A valid netmask, in the form a.b.c.d
<bits>==The number of leftmost bits in the netmask . . . 0 thru 31
<method_list>==A list of comma-separated methods (In this exemplary
embodiment, methods supported are: TCP (Transmission Control
Protocol), UDP (User Datagram Protocol), and ALL.

One compartment management utility that may be utilized for manipulating compartments is a command-line utility executable to set rules for controlling the communication (or access) of a compartment to a resource (e.g., to other compartments and/or network interfaces). As described above, according to one embodiment, such command-line utility may be named “tlrules,” and use of such utility may take the form “tlrules ‘rule description’,” for example. For instance, according to one embodiment, rules are set to control the communication of compartments with each other and with the network interfaces. The tlrules utility may be executed to perform such tasks as listing all rules currently configured on the system, loading rules from a file, loading rules from the command line, and deleting rules contained within a file or specified on the command line, as examples. In the exemplary implementation shown with FIG. 4, by default, tlrules and associated command-line utilities expect to find the compartment mapping file “cmap.txt” (in stable storage 405) in the /etc/tlinux/conf directory.

To add a rule, the user can enter “tlrules -a <filename>” (to read a rule from a text file, where <filename>is a file containing rules in the format described above), or “tlrules -a rule” (to enter a rule on the command line). For instance, to add multiple rules contained within a file, the command “tlrule -a rulefile.txf” may be executed, which will add rules contained in the “rulefile.txt” file. On the other hand, to add a rule allowing the compartment “dev” to query the DNS server on host 192.168.10.3, the following command may be executed:

tlrules -a “COMPARTMENT dev ->HOST 192.168.10.3 PORT 53 METHOD udp NETDEV any”.

To delete a rule, the user can enter “tlrules -d <filename>”, or “tlrules -d rule”, or “tlrules -d ref” (in this form, a rule can be deleted solely by its reference number which is output by listing the rules using the command tlrules -l, which outputs or lists the rules in a standard format with the rule reference being output as a comment at the end of each rule). As a further example, to delete the rule allowing the compartment “dev” to query the DNS server on host 192.168.10.3 the following command may be executed:

tlrules -d “COMPARTMENT dev ->HOST 192.168.10.3 PORT 53 METHOD udp NETDEV any”.

As still a further example, to delete all of the rules in the file “rulefile.txt,” the command “tlrules -d rulefile.txt” may be executed.

In at least one embodiment, any syntax or semantic errors detected by tlrules will cause an error report and the command will immediately finish, and no rules will be added or deleted. If a text file is being used to enter the rules, the line number of the line in error will be found in the error message.

Another command-line utility provided by this exemplary embodiment of the present invention is known as “tlutils”, which provides an interface to the lns kernel-module (described above with FIG. 4). Its most important function is to provide various administration-scripts with the ability to spawn processes in a given compartment and to set the compartment number of interfaces. Examples of its usage include:

1. “tlnetcfg setdev eth0 0xFFFF0000”—Sets the compartment number of the eth0 network interface to 0xFFFF0000.

2. “tlsetcomp WEB -p cap_mknod -c /bin/bash”—Switches to compartment WEB, removes the cap_mknod capability and invokes bash.

Exemplary Utilities for Manipulating Compartments

According to at least one embodiment of the present invention, “tlcomp” utilities are provided for manipulating compartment. Such “tlcomp” utilities may comprise command-line utilities for adding, deleting and renaming compartments, as examples. Various specific examples of such tlcomp utilities are described below.

A first compartment management utility that may be utilized for manipulating compartments is a command-line utility for adding/creating a new compartment to a system. According to one embodiment, such command-line utility may be named “tlcompadd,” and use of such utility may take the form “tlcompadd [compartment name]” or “tlcompadd [options flags] [compartment],” as examples. In this example, tlcompadd with a specified compartment name as an argument will add a new compartment having such specified name to the system. More specifically, the compartment having the specified name will be added to the stable storage database (stable storage 405 of FIG. 4) on the system and provide a reference in the kernel-level memory (memory 421A of FIG. 4). In at least one embodiment, once the compartment is created via the tlcompadd command, it will instantly be available to the system to use. Thus, compartments may be dynamically created from the user-space of the OS, without requiring re-booting of the system to have such created compartments available for use.

According to at least one embodiment, the compartment name can comprise in any alphanumeric (A-Z and 0-9) characters, a dash (−), and underscores (_). The compartment name specified by the user provides a user-friendly representation of the compartment. However, as described with the exemplary implementation of FIG. 4, in at least one embodiment an internal database is maintained both in memory (e.g., memory 421A in FIG. 4) and stable storage that maps the user-friendly name to a number identifying the compartment (e.g., a text file “cmap.txt” 405 in FIG. 4).

When implemented in an OS architecture as that described above, it may be beneficial to have certain compartments created within a chroot filesystem. Thus, in at least one embodiment, in addition to creating a compartment with a specific compartment name, an argument (or option flag) may be provided which will create a chroot filesystem and initialization scripts for the compartments. The purpose of this is that it provides an extra layer of security in that a process (e.g., application) running in a compartment may run in a chroot area of the filesystem thus making everything outside of the chroot area of the filesystem unavailable to the processes within the compartment. Initialization scripts allow the starting of processes within the compartment (see tlcompstart below for further explanation).

Another compartment management utility that may be utilized for manipulating compartments is a command-line utility for renaming an existing compartment. According to one embodiment, such command-line utility may be named “tlcompren,” and use of such utility may take the form “tlcompren [current name] [new name],” for example. In this example, tlcompren having a specified current compartment name and new compartment name as arguments will rename the compartment having the “current name” argument to the “new name” argument. More specifically, according to at least one embodiment, the internal number representing the compartment remains the same, while the user-friendly name of the compartment is changed. If the compartment being renamed has a chroot filesystem and initialization files, these are also renamed where necessary to “new name.” In at least one embodiment, the renaming of a compartment is a dynamic process such that after execution of the tlcompren command, references may immediately be made to the “new name.”

Another compartment management utility that may be utilized for manipulating compartments is a command-line utility for removing an existing compartment from the system. According to one embodiment, such command-line utility may be named “tlcomprm,” and use of such utility may take the form “tlcomprm [option flags] [compartment name],” for example. In this example, tlcomprm having a specified compartment name removes the specified compartment from the system. According to at least one embodiment, an optional flag may be included to specify that all chroot files and initialization files for such compartment also be removed. Preferably, this command removes both the kernel-level memory and stable storage references to a compartment. Additionally, in at least one embodiment, the removal of a compartment is a dynamic process such that after execution of the tlcomprm command, the name of the removed compartment may be re-used (e.g., in adding a new compartment having such name) if so desired.

Another compartment management utility that may be utilized for manipulating compartments is a command-line utility for switching from a current compartment to a destination compartment. Thus, if a user (e.g., system administrator) is currently within a particular compartment, the user may utilize such command-line utility to switch to another “destination” compartment. According to one embodiment, such command-line utility may be named “tlsetcomp,” and use of such utility may take the form “tlsetcomp [destination compartment] [option flags] [command to execute],” for example. In this example, tlsetcomp having a destination compartment name switches the user's login process from a current compartment to the destination compartment. By default if executed with just the “destination compartment” and no options, the login shell of the user will simply switch to the new compartment. Optionally, an argument, such as -p, may be included to drop or add some capabilities for the “destination compartment,” for example. For instance, the command “tlsetcomp [destination compartment] -p -chown” may be utilized to switch a user's login process from a current compartment to the destination compartment, but the destination compartment will not be able to execute the “chown” command to change the ownership of files. According to at least one embodiment, options available to dropping capabilities includes those commonly in the Linux/Unix file “capabilities.h.”

Further, the tlsetcomp command may be used to both switch compartments and execute a command in the destination compartment. For example, the command “tlsetcomp [destination compartment] -c/bin/ps-ef” may be utilized to switch to the destination compartment and execute the ps command to list all processes within the “destination compartment”.

Another compartment management utility that may be utilized for manipulating compartments is a command-line utility executable to display the current compartment that the user's login process is contained in. According to one embodiment, such command-line utility may be named “tlgetcomp,” which will display the current compartment that a user's login shell is in. Thus, for instance, a user may execute the tlgetcomp command to display the compartment that the user's login shell is currently in. The user may then use the tlsetcomp command to change to a different compartment, which if the tlgetcomp command is executed thereafter will display the new compartment to which the user switched.

Another compartment management utility that may be utilized for manipulating compartments is a command-line utility for executing a startup script of a compartment. Such a compartment startup script may initiate at least some of the following tasks:

1) start a compartment specific process, such as a web server;

2) load the communication rules specific to the compartment;

3) configure filesystem protection rules specific to the compartment; and

4) seal the compartment to stop execution of suid scripts or transition to root from non-root processes within the compartment.

As described above, according to at least one embodiment, such location of the startup script for a compartment is /etc/tlinux/init/<compartment name>/startup. According to one embodiment, such command-line utility for initiating the startup script of a compartment may be named “tlcompstart,” and use of such utility may take the form “tlcompstart [compartment name],” for example. For instance, the command “tlcompstart web” will execute the startup script for the “web” compartment, which may switch to the chroot area of the filesystem for compartment “web” and then start the processes that supply web pages.

Similarly, a compartment management utility that may be utilized for manipulating compartments is a command-line utility executing a shutdown script for shutting down a compartment. According to one embodiment, such command-line utility may be named “tlcompstop,” and use of such utility may take the form “tlcompstop [compartment name],” for example. The utility tlcompstop typically reverses the above-described tlcompstart command. For instance, tlcompstop may initiate one or more of the following tasks:

1) unsealing the compartment;

2) unloading the file system rules;

3) removing the communication rules; and

4) stopping the application specific process, such as a web server.

As described above, according to at least one embodiment, such location of the shutdown script for a compartment is /etc/tlinux/init/<compartment name>/shutdown. The above-described startup and shutdown scripts may comprise text and certain commands, including commands that are part of the compartment utilities, such as tlrules.

Another compartment management utility that may be utilized for manipulating compartments is a command-line utility that is executable to list all compartments currently included within a system. According to one embodiment, such command-line utility may be named “tlcompstat.” Similarly, a compartment management utility may be provided that is executable to list all processes running (or executing) on the system and the name of the compartment in which each compartment is executing. According to one embodiment, such command-line utility may be named “tlprocstat.”

Another compartment management utility that may be utilized for manipulating compartments is a command-line utility executable to seal a compartment. According to one embodiment, such command-line utility may be named “tlcompseal,” and use of such utility may take the form “tlcompseal [compartment name],” for example. This utility provides an added security feature. Sealing a compartment disables the ability for processes within the compartment to transition to root (e.g., “su-root”) or execute suid programs or scripts. For instance, the command “tlcompseal web” will seal the web compartment such that no process executing therein can transition to root.

On the other hand, a utility may be provided to unseal a compartment. According to one embodiment, such command-line utility may be named “tlcompunseal,” and use of such utility may take the form “tlcompunseal [compartment name],” for example. This utility executes to unseal a sealed compartment to permit the transition to root (e.g., “su root”) and the execution of suid programs or scripts if the filesystem access control lists (ACLs) permit.

Yet another compartment management utility that may be utilized for manipulating compartments is a command-line utility executable to load an input file that contains a compartment name and number mapping within the OS. According to one embodiment, such command-line utility may be named “tlregcompas,” and use of such utility may take the form “tlregcompas [file name],” for example. This command may be used at system boot, for example. For instance, in one embodiment, all compartments are stored in kernel-level memory and in stable storage in a file. When the system boots, the tlregcompas command may be used to load the stable storage entries into memory.

In at least one embodiment, any syntax or semantic errors detected by tlcomp will cause an error report and the command will immediately finish, and no compartments will be manipulated (e.g., added or deleted).

Various utilities have been described above, including examples of various command-line utilities, which may be available through an OS in accordance with various embodiments of the present invention. Accordingly, various embodiments of the present invention enable compartment management (e.g., manipulation of rules and/or compartments) to be performed from the user space in an efficient and user-friendly manner. For instance, a user is not required to edit a configuration file in which such rules and/or compartments are defined, but may instead execute command-line utilities to perform a desired management action (e.g., adding or deleting a rule and/or compartment). Also, it should be understood that further compartment management utilities in addition to those described above may be included in certain embodiments of the present invention. As examples, in addition to those command-line utilities described above for manipulating compartments, command-line utilities may be provided for performing such manipulation as resizing an existing compartment, adding a process to a compartment, and removing a process from a compartment.

In addition to enabling an efficient and user-friendly technique for managing compartments, in certain embodiments error-prevention checks may be made by the compartment management utilities to aid a user in avoiding errors that may otherwise be encountered in performing compartment management. For instance, a user is traditionally required to edit a configuration to add a compartment within a system. If the user makes an error in the configuration file, such as duplicating a compartment name (i.e., naming the newly added compartment the same as an existing compartment), such error is not indicated to the user. Further, the changes made to a configuration file in prior art systems typically take effect only after the system re-boots. Accordingly, the user may only discover the error after a system re-boot, or alternatively, the error may be fatal to the point that the system will not re-boot, requiring that the operating system be reinstalled on the system.

Examples of error-prevention checks that may be performed by the compartment management utilities in certain embodiments of the present invention include checking for compartment name duplication and checking that sufficient memory is available, as examples. While these exemplary error-prevention checks are described further below, it should be understood that many other types of error-prevention checks may be performed by the compartment management utilities in various embodiments to aid a user. In one embodiment, compartment name duplication is checked by a utility (e.g., the tlcompadd or tlcompren utilities) calling “lns” to verify that a name does not already exist within the “lns” security module. Additionally, upon adding a new compartment (e.g., with the tlcompadd command), the utility being executed may perform a check to ensure that sufficient memory exists to add the new name and number mapping to the “lns” security module.

As a security check, only users with proper permission may execute all or a portion of the above-described compartment management utilities (e.g., to manipulate rules and/or compartments). According to at least one embodiment, the user has permission to execute such compartment management utilities as adding a compartment, etcetera, if the user is in root on the system and has an “admin bit” set for the user's ID. The admin bit is a special bit that is set within the user's login process. The bit can only be obtained by logging in through secure channels, which are controlled. Such secure channels include via a secure shell connection “SSH” or by physically logging on at the console of the machine.

Various embodiments of the present invention further enhance efficiency of compartment management by enabling rules and/or compartments to be manipulated (as described above) dynamically, without requiring a system re-boot in order for the actions taken via the utilities to become effective within the system. As described with FIG. 9 above, prior art systems commonly require that a user edit a configuration file in order to manipulate compartments and/or compartment rules, and the system is typically required to be re-booted before changes made to the configuration file takes effect within the system. However, various embodiments of the present invention enable utilities to be utilized to manipulate compartments and/or compartment rules in a dynamic manner that does not require a system re-boot in order for such manipulation to take effect within the system.

For example, in at least one embodiment, a configuration file comprises text (e.g., commands, etcetera) that provides details that enable the system to re-boot with the correct number of compartments. That is, the configuration file is utilized as a reference upon boot-up of the system to enable the system to identify the compartments that exist thereon. If, during system run-time, a user utilizes a compartment management utility to add a new compartment (e.g., uses the above-described tlcompadd command-line utility), such utility executes to automatically generates the number representing the new compartment, and stores such number, as well as the user-friendly name of the compartment, to memory 421A (of FIG. 4). At this point, a user with the correct permission is immediately able to query the compartment by name and may add rules for such compartment. The utility may also update the configuration file to reflect such compartment manipulation (e.g., addition of a new compartment), such that if the system were to be re-booted it would recognize the proper state of the compartments, reflecting manipulation(s) made since its previous boot-up. Likewise, compartment rules may be manipulated in a dynamic manner. For instance, compartment rules may be added via the above-described “tlrules” command, which may execute to add the desired rule for a compartment to the rule database 416 (FIG. 4), and such added rule will therefore take effect immediately. For example, upon an access request being received after the addition of rule via the “tlrules” command, security module 421 will access rule database 416, which includes the newly added rule that may be utilized to determine whether access is permitted for the requesting compartment. Thus, the utilities are preferably executable to enable dynamic performance of compartment manipulation actions, without requiring a system re-boot.

Turning to FIG. 11, an exemplary operational flow is illustrated for creating a compartment and then renaming it in accordance with one embodiment of the present invention. In operational block 1101, the command “tlcompadd comp” is performed to add a new compartment named “comp.” As described above, according to at least one embodiment, the effect of execution of this command is to generate a number that is used internally to reference the new compartment named “comp.” In at least one embodiment, the compartment “comp” and its generated number are stored within an configuration file and copied into kernel-level memory of the system in order to dynamically make the new compartment available.

Thereafter, in block 1102 of this example, the command “tlcompren comp comp2” is executed to rename the compartment “comp” to “comp2.” According to at least one embodiment, renaming of a compartment changes the name within the configuration file and the name to number mapping within the kernel-level memory.

Turning now to FIG. 12, another exemplary operational flow is provided, which provides an example of changing a user's login process from one compartment to another in accordance with one embodiment of the present invention. In the example of FIG. 12, operational block 1201 is first executed in which the command “tgetcomp” is performed. The command “tlgetcomp” executes to display the current compartment, which in this example is returned as “system.” In block 1202, the command “tlsetcomp web” is executed to change from the “system” compartment to the “web” compartment. It should be noted that for such a change from the “system” compartment to the “web” compartment to actually succeed, the “web” compartment must exist on the system (e.g., has been previously added via the tlcompadd command). According to at least one embodiment, within a process structure is included a field that represents the compartment to which the process belongs (or is contained). For instance, by default in a Linux system, if a user logs in at the console, the user's login process structure will have an additional field called “dev” (i.e., compartment “dev”). If the user then starts a web daemon, that too will have the field in the process structure called “dev”, as it is a child process spawned by the user's login process. In at least one embodiment, access control utilizes the name provided in the compartment identifying field of the process structure. For example, if a syscall is received from a process having a compartment identifier of “dev”, a lookup is performed by security module 421 to confirm whether “dev” is allowed to execute the requested syscall. When the user executes the tlsetcomp the compartment identifying name within the process is dynamically changed and rules are then applied to the compartment.

Further, in at least one embodiment, the change from one compartment to another compartment occurs as a result of the executed command-line utility (e.g., tlsetcomp”) in a manner that is transparent to the user/application that utilized such command-line utility. According to at least one embodiment, such a change of compartments occurs dynamically such that when command “tlgetcomp” is executed again in block 1203, the compartment name “web” is displayed as the current compartment. Thus, the “tlgetcomp” command executed in block 1203 confirms that the current compartment is now “web,” rather than “system.”

As a further example, FIG. 13 another exemplary operational flow is provided, which provides an example of utilizing a compartment management utility to change to a different compartment and execute a command therein. From time to time, it may be desirable to initiate execution of a process in one compartment from another compartment. For example, a web server may be included within a system that should execute within the “web” compartment, but the user's login process may currently be in the “system” compartment. Rather than changing into the web compartment to start the web server, it may be more efficient to enable the user to initiate the web server within the web compartment from the system compartment. Thus, at least one embodiment of the present invention provides a command that may be utilized to effectively change from a first compartment to a second compartment, execute a desired command in the second compartment, and return to the first compartment.

In the example of FIG. 13, operational block 1301 is first executed in which the command “tlgetcomp” is performed. The command “tlgetcomp” executes to display the current compartment, which in this example is returned as “system.” Thus, the current compartment of the login process is “system” (e.g., the user's login process has a tag with the label “system”). In block 1302, the command “tlsetcomp web -c /bin/httpd -start” is executed. The command of block 1302 executes to change from the “system” compartment to the “web” compartment, perform the command to start the web server daemon, and then tlsetcomp exits leaving the web server daemon running in the web compartment. According to at least one embodiment, the “tlsetcomp” command executes in the “system” compartment to initiate a child process (the web daemon), but just before doing so, it changes the label within the process structure from “system” to “web” to start the web daemon as a child in the web compartment. Thereafter, it reverts back to “system” before the “tlsetcomp” command exits. Thus, when command “tlgetcomp” is executed again in block 1303, the compartment name “system” is displayed as the current compartment.

What is claimed is:

1. A method of administering a processor-based system, said method comprising the steps of:
implementing at least one compartment for containing at least one process executable on said processor-based system; and
providing at least one operating system command-line utility executable to manipulate said at least one compartment.

2. The method of claim 1 wherein said at least one compartment defines whether said at least one process contained therein is allowed access to particular system resources.

3. The method of claim 1 wherein said at least one process is labeled to identify the compartment in which it is contained.

4. The method of claim 1 wherein said at least one command-fine utility executable to manipulate said at least one compartment comprises at least one command-line utility executable to perform at least one type of compartment manipulation selected from the group consisting of:
adding a new compartment, renaming an existing compartment, removing an existing compartment, resizing an existing compartment, adding a process to a compartment, and removing a process from a compartment.

5. The method of claim 1 wherein said implementing step comprises:
defining said at least one compartment in at least one configuration file.

6. The method of claim 5 wherein said at least one command-line utility is executable to manipulate said at least one compartment without requiring a user to edit said at least one configuration file.

7. The method of claim 1 wherein said implementing step comprises:
providing at least one rule that defines containment of said at least one compartment in at least one configuration file.

8. The method of claim 7 further comprising the step of:
providing at least one command-line utility executable to manipulate said at least one rule.

9. The method of claim 8 wherein said at least one command-line utility executable to manipulate said at least one rule comprises at least one command-line utility executable to perform at least one type of rule manipulation selected from the group consisting of:
adding a new rule for a particular compartment, removing an existing rule for a particular compartment, and listing all rules for a particular compartment.

10. A system comprising:
at least one processor;
an operating system implementing at least one compartment to which at least one process executable on said system can be associated;
at least one configuration file defining said at least one compartment; and
means for performing management of said at least one compartment without requiring that a user edit said at least one configuration file in which said at least one compartment is defined.

11. The system of claim 10 wherein said means for performing management of said at least one compartment further enables management actions initiated via said means for performing management to be performed dynamically, without requiring that the system be re-booted in order for said management actions to be effective within said system.

12. The system of claim 10 wherein said performing management of said at least one compartment comprises manipulating said at least one compartment.

13. The system of claim 12 wherein said manipulating said at least one compartment includes at least one type of manipulation selected from the group consisting of:
adding a new compartment, renaming an existing compartment, and removing an existing compartment, resizing an existing compartment, adding a process to a compartment, and removing a process from a compartment.

14. The system of claim 12 wherein said means for performing management of said at least one compartment farther enables manipulating of said at least one compartment to be performed dynamically, without requiring that the system be re-booted in order for compartment manipulation to be effective within said system.

15. The system of claim 10 wherein said performing management of said at least one compartment comprises switching from a first compartment to a second compartment.

16. The system of claim 10 further comprising:
at least one configuration file including at least one rule defining containment of said at least one compartment.

17. The system of claim 16 wherein said performing management of said at least one compartment comprises manipulating said at least one rule.

18. The system of claim 17 wherein said manipulating said at least one rule comprises at least one type of manipulation selected from the group consisting of:
adding a new rule for a particular compartment, removing an existing rule for a particular compartment, and listing all rules for a particular compartment.

19. The system of claim 10 wherein said means for performing management comprises at least one operating system command-line utility executable to manage said at least one compartment.

20. A computer-readable medium including instructions executable by a processor, said computer-readable medium comprising:
library of software functions for managing at least one compartment implemented by an operating system, wherein at least one process can be associated with said at least one compartment and said at least one compartment defines accessibility of resources for said at least one process associated therewith; and
said library of software functions includes at least one command-line utility executable to manipulate said at least one compartment.

21. The computer-readable medium of claim 20 wherein at least one command-line utility executable to manipulate said at least one compartment includes at least one type of manipulation selected from the group consisting of:
adding a new compartment, renaming an existing compartment, and removing an existing compartment, resizing an existing compartment, adding a process to a compartment, and removing a process from a compartment.

22. The computer-readable medium of claim 20 wherein at least one configuration file is implemented on a system to define said at least one compartment.

23. The computer-readable medium of claim 22 wherein said at least one command-line utility is executable to manipulate said at least one compartment without requiring that a user edit said at least one configuration file.

24. The computer-readable medium of claim 20 wherein at least one rule is implemented to define accessibility of resources allowed for said at least one compartment, and wherein said library of software functions further includes at least one command-line utility executable to manipulate said at least one rule.
